(19) United States
(12) Patent Application Publication
(10) Pub. No.: US 2019/0164161 A1
(43) Pub. Date: May 30, 2019

(54) System and method for Sharing account anonymously and using image coded account for easy transactions

(71) Applicants: Hashem Sultan, Pembroke Pines, FL (US); Mark Sultan, EauClaire, WI (US)

(72) Inventors: Hashem Sultan, Pembroke Pines, FL (US); Mark Sultan, EauClaire, WI (US)

(21) Appl. No.: 15/826,594

(22) Filed: Nov. 29, 2017

(51) Int. Cl. G06Q 20/40; G06Q 20/32

(52) U.S. Cl. CPC G06Q 20/4012; G06Q 20/3276

(57) ABSTRACT

A method and device for financial institutions is provided, comprising a standard bank management computer incorporating a code generator and code reader, software for creating ancillary escort account allowing customer to share the escort/ancillary account with other users. Furthermore, the system will enable customers to add and delete authorized users at any time, to manage the account, and to perform secure anonymous transactions online without disclosing any personal information.

The system will enable customer to share his account with other users using the generated image code by the bank with assigned different PIN (Personal Identification number).

The new system will provide customer with additional privacy. The identity of the authorized user sharing the account may be anonymous.

The image coded account can be used by both the owner and the anonymous user to withdraw cash without using a debit card, pay merchants, pay bill on line for any payee or merchant accepting barcode account as a method of payment. Furthermore, the system will enable users and customer to create a cashier check online and use it as needed.

### FIELD OF THE INVENTION

The present disclosure generally relates to financial transactions, and more particularly, a system and method of processing financial transactions, sharing account with privacy, and easy money transfer.

### BACKGROUND OF THE INVENTION

Owners of small businesses usually authorize their accountant/manager to pay the business bill online, purchase business supply, and to pay for other office expense such as air ticket, hotels accommodation, dinner meeting, unexpected travel expenses. This will require the business owners to provide their credit card information to their employees.

Identity theft is a major concern to most of us. The most common type is financial identity theft, where someone wants to gain economic benefits in someone else's name. This includes getting credits, loans, goods and services, claiming to be someone else. Corrupted employee may take advantage of the information, careless employee may let the information fall in the wrong hands of others.

Information privacy is a large concern for many people. Privacy is the state or condition of being free from being observed or disturbed by other people. A person may have another person, a mother, a relative, a friend, a mistress, or a love one, who needs the first person's help and support. A person may wish to give his financial support anonymously.

Financial help is sometimes needed by a loved one in emergency at a remote location. Example, a son who loses his credit cards while he is in Europe or Japan, while his parents are in Miami.

Although there are many ways of transferring money over the world, they are all either costly, inconvenience, or impractical. Wire transfer, Western union, PayPal. Recently, many new other methods for easy money transfer between buyer and seller using MSM, internet services like Zelle.

Parents may like to share their personal account with their children, to allow them to pay for their college expenses, pay their bills, pay for purchases at merchant store, get cash, and pay for other personal expenses,

Many patent publications tried to address the issue of privacy, anonymity, sharing account, transactions without using a bank card, and easy transfer. None of the cited references had described a practical efficient method to address these goals.

I—Cited References in Relation to Anonymity and Privacy:

Mina, in his patent application publication Number US 2011/0119190 describe a secure transaction between buyer and seller. He discloses methods, apparatus, systems, and non-transitory, tangible computer-readable media associated with use of transaction authorization codes to each of the parties involved in a buying and selling transaction.

Allison, in his patent application publication number US 2011/0282788 A1, describes a device and a method for autonomous online payment to the payee via an Internet accessible address, without disclosing any personally identifiable information of the payer.

Gerson, in his U.S. Pat. No. 8,831,979 B1, Sep. 9, 2014, describes a method for anonymous processing of a purchasing request. Initially, a text message comprising the purchasing request is received, by a processing platform, from a mobile phone. A current authorization code comprising a random number is generated in response, and then sent, via a text message, to the mobile phone. A merchant is provided with a pending authorization code, who then sends a communication including the pending authorization code to the platform. The purchasing request is validated in part by determining whether the pending authorization code is identical to the current authorization code.

Mao, in his patent application publication number US 2014/0222675 A1, anonymous method of transferring funds from one party to another without releasing any identifying information about either party. The method is comprised of downloading a mobile application which can be downloaded onto any mobile platform that enables users to register and send their personal information along with their bank account number upon registration. Since this information is never transmitted again, the risk of unauthorized usage by hackers decreases dramatically. The information is stored on a secure central database that cannot be accessed except by the database itself. The application itself will allow a person requesting the to specify the amount of money requested on their mobile application, which relays this information to a web server and then to the central database. The mobile application will present the receiver with a QR code, which can be scanned by the payer's mobile device using the same mobile application. Once the payer is authenticated, the funds are transferred to and from each individual bank account. Each party receives confirmation that the transaction was completed without having to know the identity of the other party.

Schattauer, in his U.S. Pat. No. 8,423,457 B1, dated Apr. 16, 2013, describes an anonymous mobile payment enable a user to make and/or receive payments Without disclosing personal or private information to another party. In some aspect, a provider of a payment may request an anonymous payment for a specified value from a host. In response, the host may transmit to the Provider a code that is available for redemption. The provider may then relay the code to a recipient, who may redeem the code from the host. In other aspects, a recipient may request a temporary identifier (special code) from a host. The recipient may relay the temporary identifier to a provider, who may in turn transmit a payment, via the host, using the temporary identifier. The recipient may then claim the payment from the host.

II—Cited References for Account Sharing;

Evans, in his patent application publication #2012/0278216 A1, describes a sharing self-created account for storing assets with at least with one other device. By Way of example to his system, a user can deposit money at a kiosk or With a vendor Who then transfers the money to an account the user created that the user can access through, for example, a cell phone.

Huh, in his U.S. Pat. No. 7,665,657 B2, date Feb. 23, 2010, discloses a bank transaction method linking accounts via common accounts, Wherein the existing accounts of the account holder and/or newly opened plural accounts link arbitrarily as defined by the account holder for convenient transactions between account holder s primary account and other's secondary accounts without using account numbers of the concerned accounts.

Alvarez, in his U.S. Pat. No. 8,204,829 B2, date Jun. 19, 2012, disclose systems and methods for money sharing using multiple stored-value cards associated with a stored-value account. A system for money sharing includes a processor and a storage device. The processor receives a deposit amount and assigns an account value to a stored-value account. The processor dispenses the stored-value cards, Which are configured to enable a cardholder to access the stored-value account to withdraw at least a part of the account value from the stored value account. The multiple cards can also be used to deposit additional amounts into the stored-value account. The storage device stores the stored-value account.

Simunovic; in his patent application publication # US 2008/0281721 A1, describes systems and methods for facilitating online money management for children and their parents. The systems

and methods provide a convenient, easy, safe, and controlled environment that teaches financial responsibility. The system comprises a parental control module configured to create a parent account and one or more child accounts and the administering of the child accounts, a child account management module providing an interface to each of said one or more child accounts, and a financial management module allowing for the earning of money, processing deposits, transfers and withdrawals for said one or more child accounts. Each child account may include a savings sub-account, a sharing sub-account, and a spending sub-account.

III—Cited References in Relation to Barcode Use

Laracey, in his U.S. Pat. No. 8,632,000 B2, date Jan. 21, 2014, disclose a method and a system for mobile devices to conduct transactions with ATM devices without need to insert a traditional payment card. At the ATM, customer mobile device interacts with the ATM display to select an option to “Conduct a Mobile Transaction”. This causes the ATM device to send a message to a transaction management system notifying the system that a transaction is to be conducted at that ATM device. The transaction management system creates an “ATM code” to be displayed at the ATM device. (QR code for example). Customer then uses his/her iPhone to capture the code from the ATM device. The captured ATM code and transaction details are transmitted from the iPhone to the transaction management system, and the transaction management system validates the transaction and transmits instructions to the ATM device to dispense the funds.

Leyva, in his patent publication application # US 2014/0067674 A1, he discloses a system and a method and computer program product for processing transactions using a dynamic security code. In various embodiments, account authorization system may generate a plurality of dynamic security codes. The account authorization system may transmit the dynamic security codes to a portable consumer device. The portable consumer device may generate a payment code comprising a transaction account number and a dynamic security code. A merchant may scan the payment code on the portable consumer device. The account authorization system may receive a transaction request from a merchant or from the portable consumer device. The transaction request may comprise the transaction account number and the dynamic security code. The account authorization system may detect a dynamic security code in the transaction request and determine that the transaction account number and the dynamic security code match a transaction account number and dynamic security code stored on a database. The account authorization system may transmit an authorization message to the merchant.

Pandhare, in his patent application publication # US 2014/0172701 A1, discloses a system and method for initiating financial transactions utilize the display of a two dimensional barcode on a mobile electronic device. A payer enters a sequence number pertaining to a prepaid transaction into a payer device and securely transmits these data to a payer bank. The bank generates a password-protected two-dimensional barcode using the sequence number. The barcode may be a QR code. The barcode and Password are separately sent to a Payee device, either directly from the bank or through the payer device using Wireless communications such as MMS or NFC. Once the password is entered, the payee device displays the barcode on a screen so it may be scanned by a payee bank scanner or ATM scanner or submitted to a payee's financial services organization system. Scanning or submitting the barcode initiates the financial transaction.

Meyer, in his patent application publication # US 2002/0128967, discloses a system and a method of payment in which payments are made using a barcode printed on the bill.

Frantz, in his U.S. Pat. No. 8,016,187 B2, date Sep. 13, 2011, describes an invention that allow the user to capture a barcode using a camera phone or any other camera-equipped communicating devices such as a PDA.

Buentello, in his U.S. Pat. No. 8,590,781 B1, date Nov. 26, 2013, disclose Systems and methods for processing checks using 2D barcodes are provided. A user submits a digital image of a check that includes a 2D barcode.

Change, in his patent publication application # US 2012/0173311 A1, disclose an ATM providing service using a 2D barcodes.

IV—Cited References Related to Easy Transfer:

CHO, in his patent publication application # US 2014/0207679, and

Bueche, in his U.S. Pat. No. 8,751,379 B1 date Jun. 10, 2014 disclose a method related to performing online money transfer operation in connection with an instant messenger installed in and executed by user equipment. First user equipment may monitor messages transmitted to and received from second user equipment through the instant messenger upon initiation of the online money transfer operation. The first user equipment may obtain information on an online money transfer event upon detection of a predetermined service initiation word based on the monitoring result. The first user equipment requests a service server to perform the online money transfer operation based on the obtained information.

Amos, in his U.S. Pat. No. 6,554,184 B1 describes an ATM machine for instant automatic money transfer.

Although, the above-mentioned applications and other systems present in the current market address some of the current problems in account sharing, account transfer, privacy, and more convenience in finance transactions, there are many flaws in the current system, and there is a need for a system that achieve all these goals and more in one single system. This is what this application is intended to achieve.

### SUMMARY OF THE INVENTION

The main objectives of this invention are to provide a system and a device which provide more privacy, decrease the chance of identity theft, allow users to share part of their accounts with their employee, allow users to share part of their account with the children, family member, friends, and the loved ones, allow users to withdraw money, pay bills, pay at merchants, and print a cashier check online without using their debit card or disclosing any personal information.

In the preferred embodiment, the current invention, describes a banking system in which the financial institution creates an escort barcode bank account to the existing customer. The request to open the barcode account can be made online using a computer, Personal Digital Assistance (PDA) device, or in person at a bank location. The ancillary account is to be used as escort account for other users. These other users are appointed by the account holder. Transferred funds are taken from the main account to the escort account. Customer may use his main account instead of escort account to share the account with authorized users of choice. The account holder assigns the money amount for each user.

Users can access their allocated funds using the same barcode of the account but with using different PIN/PW.

PIN/PW are created by the account holder and send to the users, preferably orally over the phone, but can be send in any other delivery method. Barcode and PIN are sent to the new users in a separate delivery method. Barcode image can be sent to the user by a computer, PDA devices using internet, and/or text massage, airdrop, etc. Barcode can also be send by fax or by regular mail as a printed material.

According to the embodiment of the invention, the bank management computer will add new software application, add new components such as barcode generator, and barcode reader, ATM to be equipped with barcode reader. All those updates are well known for the ordinary person in the art.

The system will enable account holder to access his account online to add more funds to the escort account, to add new users, add more funds or decrease funds for each user, delete user, and change PIN/PW for any user.

Appointed user can use the barcode image with the assigned PIN/PW to withdraw money from any ATM, bank location equipped with bar-reading capability. The barcode can be also used online or at any point of sale (POS) accepting barcode transaction.

Account holder and other authorized users may use the ancillary account to perform transactions such as withdraw cash from ATM, print cashier check online, pay bill online, make payment for purchase on line, and make payment for purchases at any POS which accept barcode transaction.

Using barcode account, account holder may perform additional transactions at ATM. He may transfer more fund to the barcode account from his main account, may deposit cash directly into the barcode account, and may access his main account using the barcode access to perform other standard ATM transactions on both accounts; main and ancillary (escort).

In other embodiment, the financial institutions apply the current invention on the main account of the existing customer s and on the main account of the new customers without the ancillary account.

Account holder, using the invention, can add several users to his main account in the same way the ancillary account works.

### BRIEF DESCRIPTION OF THE DRAWING

FIG. 1 depicts a generalized overview of the elements of the invention

FIG. 2 depicts the preferred embodiment of managing ancillary barcode account and method of sharing the account

FIG. 3 depicts an example of website page to edit users sharing the account.

FIG. 4 depicts a simplified diagram of possible transactions conducted by the appointed user of the account.

FIG. 5 depicts a cashier check created on line by either the account holder or the assigned user.

FIG. 6. Depicts transactions online using the new invention

FIG. 7 depicts a simplified diagram of possible transactions conducted by the account holder using the barcode.

FIG. 8 depicts a diagram of an alternative embodiments of the invention.

### DETAILED DESCRIPTION OF THE INVENTION

The main objectives of this invention are to provide a system and a device which provide more privacy, decrease the chance of identity theft, allow users to share part of their accounts with their employee, allow users to share part of their account with their children, family member, friends, and the loved ones, allow users to withdraw money, pay bills, pay at merchants without using their debit card or disclosing any personal information.

To clarify description of the application:
the word “customer” will be used to mean the account holder, who is the direct customer of the finance institution/bank.
The word “user” will be used to mean the authorized user(s) who are added by the account holder to the ancillary account.
The word “bank” means any financial institution.
The word “ancillary account” means an escort account taken from the customer's main account and is associated with the main account.
The word “Escort account” means the assigned money for sharing with another authorized user(s).
Escort account means the ancillary account if the fun for sharing was taken into a secondary account, and can mean the amount assigned for sharing remained inside the main account of the customer. Escort account and ancillary account can be used exchangeably.
Barcode means any type of barcodes or image such as 1D barcode, 2D barcodes such as QR, Datamatrix, CorontoSign, High capacity color barcode, Han Xin Barcode, SparQcode, Linear 2d barcode, or any readable image for a scanner/reader including face scan from the customer.
PIN will mean personal Identification number, pass word or any secondary identification such as touch ID, voice, retina, face scan, or another barcode image.

The preferred embodiment will be described here in detail. However, other embodiments may exist, and should not be constrained to those listed herein, which are only to serve as examples.

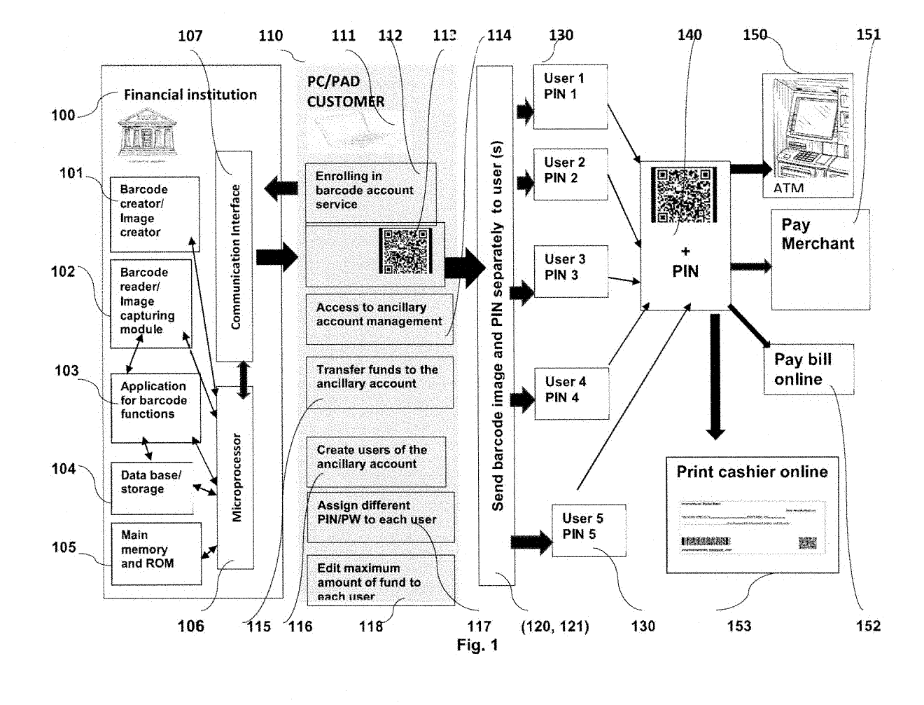

FIG. 1 illustrate the general functionality and the relations between the financial institution, customer, authorized user, and how the authorization is used by the users. The bank 100 must include a barcode generator 101, barcode reader 102, software application for the functionality of the barcode account 103, the standard components of the computer management system such as the data base 104, ROM 105, processor 106, communication interface 107, and any other components necessary for the management system known to the ordinary person in the art.

The bank will offer his customers the option of adding this service, ancillary bar account, for additional fee. Option to use the ancillary account is listed on the menu option on the display of the bank website/customer account.

Customer 110, may go to the bank to enroll in the ancillary account service with the help of bank teller, or he may access his bank account online using his PC or any PAD device 111. Typically, the customer has his own login information to access the account. Customer access their account using their standard login method, whether it is ID/PW combination, touch screen, face scan, etc.

On the option menu, the customer selects the option to enroll/use the ancillary barcode option, customer agrees on terms and condition and submit his request 112. An image/barcode is automatically generated by the host computer 113. Access to ancillary account management 114 is granted to the customer once he receives the barcode image.

Customer transfer some of his account to the ancillary account 115. The ancillary account will work as an escort account and may not be transferred back to the main account. However, customer can still access this fund using the barcode and his PIN to withdraw the funds again. This is a preferred embodiment. However, the bank may allow the customer to have a bidirectional movement of funds to and from the main account to the ancillary account.

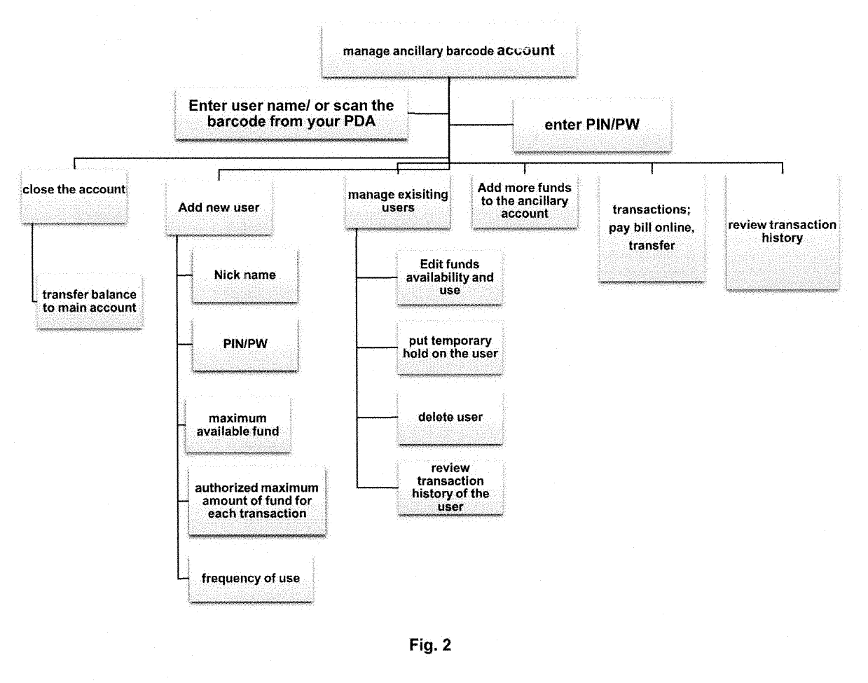

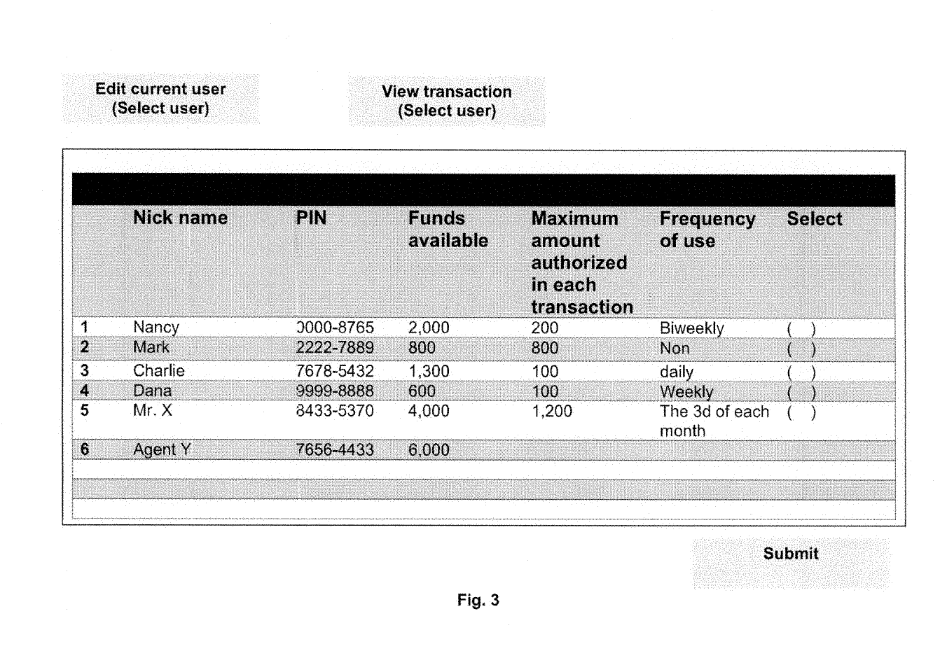

Creating new users 116, assigning different PIN to different user 117, and setting up funds for each user 118 will be explained in more detail in FIG. 2 and FIG. 3. In the preferred embodiment, two set of 4 digits PIN is provided. First four-digit set can be used to access the account in combination with the barcode and the second four digits set is used to confirm a transaction. The eight digits may be used combined as one for access the account and authorize transaction.

Once the ancillary account is created, the customer may send the barcode image 120 to the assigned user(s). The same image can be shared by all users as well as the customer. However, an option of generating a separate barcode to each user can be done and will be claimed in this application. The preferred embodiment, however, is to have one barcode for all users. This option is less costly, less time consuming, and does not add any additional security or fraud prevention. Customer can always request a new barcode if he feels his privacy was violated or there was a suspicion of hacking. Changing PIN alone is usually sufficient to prevent fraud.

The barcode can be send by the customer via the internet such as e-mail, chat, screen sharing, MSM, NFC (Near Field communication) such as Airdrop, any other communication method, and any other classic delivery method such as fax regular mail of the printed barcode image.

In a separate delivery method, the customer delivers the assigned PIN 121 to the user. Preferably in person, voice communication and less favorably through any other communication methods mentioned above. Sending the barcode and the PIN separately prevents hacking and identity theft. Furthermore, it is always preferred to send the barcode and the PIN by different method and at different time.

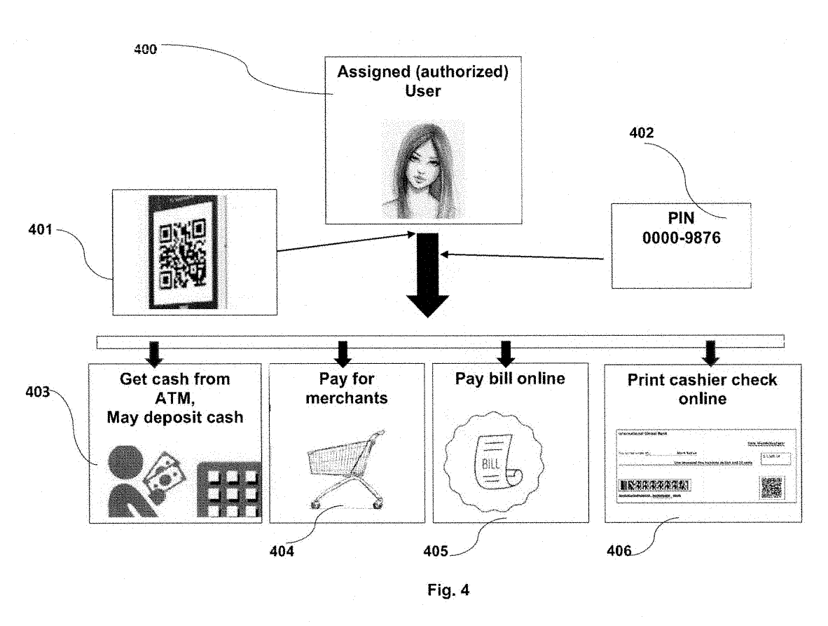

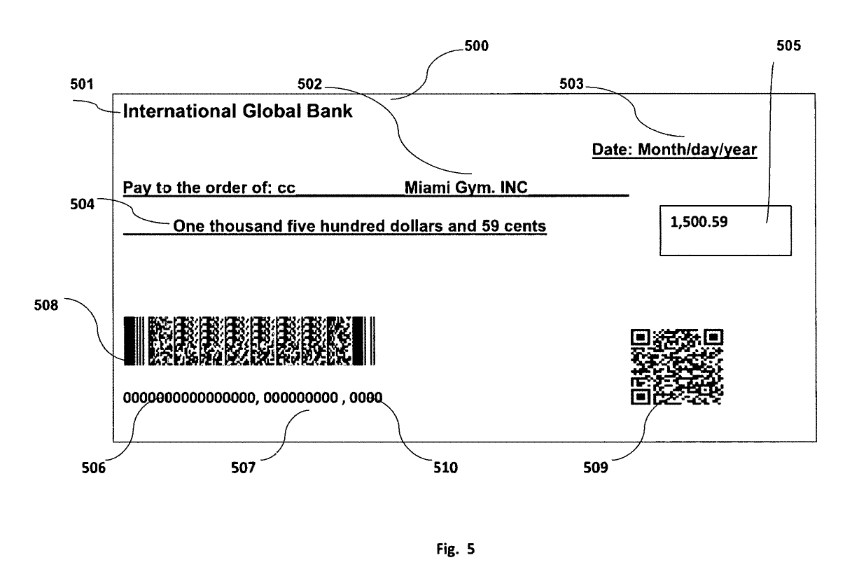

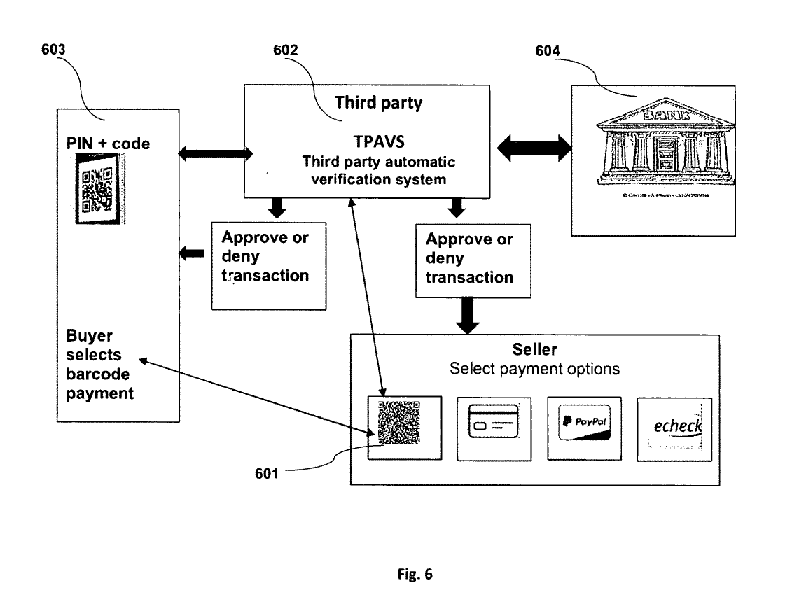

Each user 130 may use the provided barcode with his assigned PIN 140 to conduct transactions at ATM 150 to draw cash, pay merchants 151 at POS accepting barcode transactions, pay bill online 152 if the biller accepts barcode transactions, or print a cashier check online 153. Further details will be described in FIG. 4, FIG. 5, and FIG. 6

FIG. 2 is a schematic description of the ancillary barcode account management by the account holder.

Access to the account online is made by the standard login procedure; entering the ID and then the PIN/PW. Other known accessing online account is touch ID, face or retinal scan. The previously obtained barcode can be also used as a replacement to the ID entry. PIN can then be entered. Customer may create an additional PIN to himself to access the ancillary account from the online bank account. This may add some privacy to the account holder if he/she shares her/his account with a spouse, or business partner for example.

Basic options of managing the accounts are shown:

Option to close the account. If the bank allows bidirectional flow of the fund, customer may transfer the balance back to the main account. However, If the bank policy does not allow a bidirectional flow between the accounts, customer must cash his balance from ATM, or bank location. Customer may choose to close the account to avoid additional fees by the bank on the ancillary account. Customer may recreate ancillary account again when needed.

Adding new user(s) by creating a nick name to the user to hide his identity to those who may access his account, or enter the user full real name. Customer, however, must have full information on those authorized users and keep personal record of it. Government agency may need to investigate the account. This disclosure must be included in the customer agreement when the bank offer this service. Government may have to investigate suspicious accounts to prevent money laundering, support terrorism, or criminal activities.

Different PIN(s) are entered by the customer for each added user. Users may have made the arrangement with the customer to what PIN is preferred. PIN for barcode transaction is preferably an 8 digits PIN to add more security.

Customer then enter the maximum funds available to each user. If the customer wish to have the user draw the cash in installment, he may enter the maximum amount for each transaction, and the frequency of the allowed usage; example; every week, every month, biweekly or on certain day of the week or date of a month. This option is sometime necessary, for example, when a customer has a kid in a college at a remote location, or he has a family member who need additional support for living expense.

Managing existing ancillary account comprise the following; edit the funds amount by changing the available fund allocated to that user and editing the frequency and amount of each transaction, see also FIG. 3

Managing account include also option to put temporary hold on the user, review the transaction history of the user, or delete the user.

Account manager allows customer to add more fund to the ancillary account by simply editing the amount and submit the request. Automatic transfer of the fund is made once the option is verified and submitted.

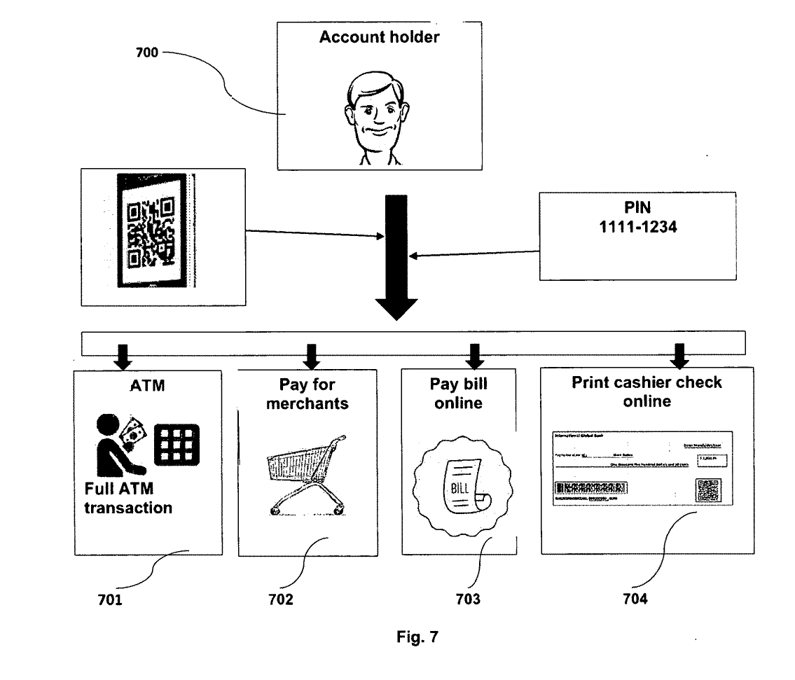

Account manager allow customer to use the ancillary account to execute transactions online; to pay bill on line, to pay for purchases, and make other transactions shown in FIG. 7

Account manager allow customer to review the whole transactions of the ancillary account or he may select to view specific user's transaction account history.

FIG. 3 is a worksheet example of adding or editing users to the account. The figure is self-illustrated.

FIG. 4 is a schematic illustration of how the assigned user 400 may use his barcode at a remote location from the customer.

To get cash at ATM 403, user present his barcode 401 to ATM machine-equipped with scan reading capability. ATM read the barcode and ask to enter PIN. Once PIN 402 is entered option to withdraw cash, deposit cash, or to check balance. ATM dispense the requested cash and print a receipt in the usual procedure.

To pay for merchant, user may present his barcode image 401 to the merchant's scanner 404, the scanner prompted a response after verifying the viability of the barcode from the bank through the machine interface with the server. When user enter his PIN 402 he will be requested to verify the amount and to agree. The bank will authorize the payment to the merchant in a very identical way to the process of using a debit card.

To pay a bill online 405, see also FIG. 6, seller must have the option of receiving payment via the image code payment 601 in addition to the other standard options of payment. If the buyer selected the image code payment, automatic transfer into a third party hosting automatic verification system (TPAVS) 602.

Buyer send the image code with PIN 603 to the TPAVS.
TPAVS verifies the authenticity transaction with the buyer's account managing system 604. Verification of the authenticity of the barcode and the PIN is done by the bank or by a third-party server (TPAVS) 602. The process is well known to the ordinary person in the art.

To print a cashier check online, the user may access the website, the page of the standard bank website, or the application of the bank which is (are) designated by the bank for this service.

At the bank website or mobile application, the customer is asked to upload the barcode image 401. The bank verifies the barcode. The user is then asked to enter his PIN 402.
Once verified, the user is asked to enter the name of the recipient of the check and the amount to be paid. User is asked to verify the entry, to agree, and then to submit. The bank will issue a cashier check 406 with the name, amount, bank information displaced. The check will include readable barcode printed on the check and optionally adding the image of the barcode account of the user. See FIG. 5 for more details.

FIG. 5 describes the cashier check 500 issued by the bank to the user. The check will look like any ordinary check, showing the bank name 501, recipient name 502, date of the transaction 503, amount to be paid written in text 504 and in numeric 505. The check will also include the bank routing number 506, the bank account number of the account holder 507. In the preferred embodiment, the account number should have additional suffix to show that the transaction was performed by an assigned user and not the account holder. Such suffix could be one or more digits, one or more letters, or any other code or symbol 510

The check will also contain a printed image of another barcode that contains information about the description of the issued check 509. This barcode is a coded information of the bank and coded information of the cashier check. The barcode is readable by scanners at any other bank. It would be preferred to add the user's barcode image 509 to the check, for further authentication.

FIG. 6 describes payment online for purchasing merchant or paying a bill. This was fully described above.

FIG. 7 describes the account holder 700 transactions using the ancillary/barcode account. In the very same way the assigned user uses his barcode transactions mentioned previously, the customer may use the ancillary account. In other words, customer may do transactions with ATM 701, pay for merchant 702, pay bill online 703, print a cashier check 704. The only difference between user and account holder is the ability of the customer to do more transaction using ATM 701. In contrast to the assigned user, the customer may have full standard ATM services such as deposit checks or accessing his main account through the barcode/PIN combination.

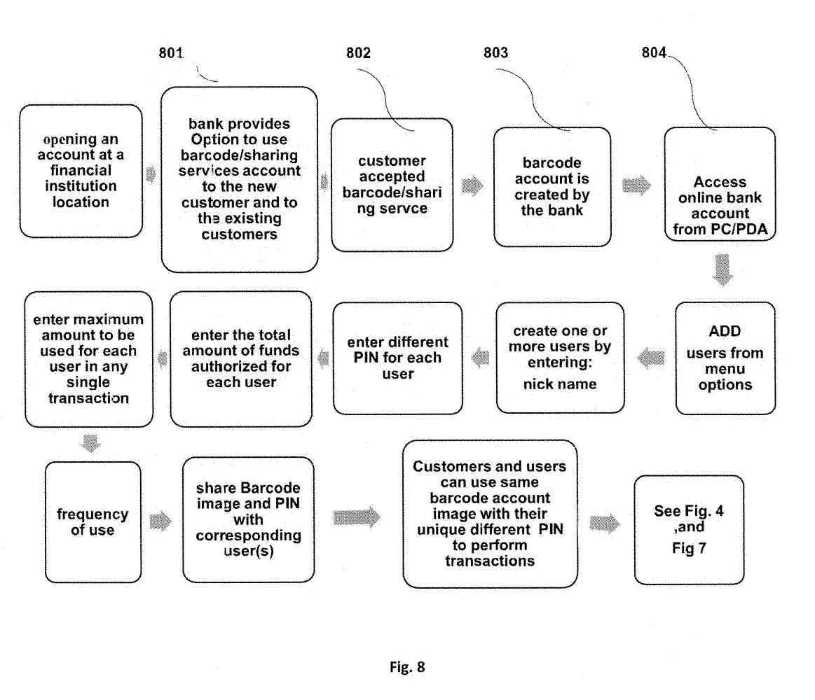

FIG. 8 illustrate a different variation of the invention.

In this variation of the application, sharing the account with other users is made through the main bank account of the customer. The bank account has the barcode option in addition to the standard services and transaction methods. The bank offers customers the option to add barcode/sharing services 801 to the main account. This option is offered to the new customers as well as to the existing customers. The option for the existing customer is provided online as well as at a bank location. When customer accepted the service 802, a barcode/sharing services 803 is created and added to the main account.

When customers enrolled in the new sharing account, they may perform the additional steps online 804;

Customer may add users by adding nick name, associated PIN, fund for each user, maximum withdraw in each transaction, and frequency of use.
Customer may then send the barcode image and the associated PIN to each user by different method and time for the barcode and the PIN as described earlier.

The disadvantage of this embodiment is many; one may drain his account and default on the user, accidental mistakes may make users withdraw much more funds than what the customer wants, less privacy when sharing the account with a partner, potential more loss with fraud and identity theft.

The above description is illustrative and not restrictive. Many variations of the invention Will become apparent to those of skill in the art upon review of this disclosure. The scope of the invention should, therefore, be determined not with reference to the above description, but instead should be determined with reference to the appended claims along with their full scope of equivalents.

1- A system for financial transaction allowing account holders to share their financial account with other users comprising of:
A computer managing system comprising code generator for generating an image that encodes customer account information, barcode reader, image capturing module, data base, memory, microprocessor(s), communication interface, and software application,
Said code generator generate a unique code to a customer account, said code contains bank information, customer's account information, and access information to the account.
Transmitting said code image to customer's PC/PDA upon customer's request by the financial institution,
Said software application enable customer to interact with said application to create an escort account,
Said software application enable customer to authorize others to use said escort account as follow; creating nick name to each user, assigning a unique a different PIN to each user, assigning fund to each user, assigning frequency of using the account and the amount used at each transaction,
Transmitting, by account holder, said barcode image and associated PIN to authorized user(s),
Said authorized users execute financial transactions using readable image code and PIN.

2- A system according to claim 1 wherein said software application enable account holder to authorize account users, to remove authorized user(s), to define the amount of fund available for each user, to define frequency and amount for each transaction, and to review account history of each authorized use.

3- A system according to claim 1 wherein the coded image is transmitted to authorized user's PC/PDA devices from account holder's PC/PDA devices

4- A system according to claim 1 wherein the coded message can be delivered via internet such as email, chat, screen sharing, text messenger, NFC (Near Field Communication) such as airdrop.

5- A method for financial transaction allowing account holders to share their account privately and/or anonymously with other users comprising of:
A bank account service allowing account holder to share part or all his account with authorized users by creating escort account associated with the customer's main account,
Said escort account is the authorized amount of fund available for authorized users by the account holder,
Said authorized users are appointed by the account holder, online or at the bank facility,
Said authorized users may be removed from the account by the account holder,
Said authorized users are given nick names without necessarily disclosing any personal information about the user(s),
said authorized users have limited transactions defined by the account holder,
said each authorized user is given a different unique PIN (Personal Identification number) assigned by the account holder,
said escort account is hosted by the bank as a separate escort account associated with the customer's account,
said escort account may stay within the customer's account,
Said escort account is associated with a unique coded image (hence barcode) readable to scanners and/or to image capturing devices,
Said escort account is the actual customer's bank account, when escort account remains within the customer's account, and is associated with a unique coded image readable to scanners and/or to image capturing device,
Said barcode contain the bank information, customer's account information, and the access information to the account,
said barcode allows customer and said authorized users to communicate directly or indirectly with the hosting computer of the bank,
said barcode allows customer and/or said authorized users to access the escort account and execute transactions when combined with at least one unique associated PIN(s),

6- A method according to claim 5 wherein account's holder may add or delete authorize users, may add or decrease amount of funds available for each user, may redefine frequency and amount for each transaction, and may review account history of each authorized use.

7- A method according to claim 5 wherein the coded image is transmitted to authorized user's PC/PDA devices from account holder's PC/PDA devices

8- A method according to claim 5 wherein the coded message can be delivered via internet such as email, chat, screen sharing, text messenger, NFC (Near Field Communication) such as airdrop

9- A system allowing account holder and authorized users to execute ATM/bank teller device's transactions without using debit card comprising:
A readable coded image associated with the customer's bank account. Said readable image is on a mobile electronic device for display of the image by the user to ATM and bank teller devices, said readable image may be printed on a document for display of the image by the user to ATM and bank teller devices
Said ATM and bank teller devices are capable of reading the displayed image, wherein displaying of the image causes the ATM to initiate the communication with the bank's computer management system for verification of the image,
Said bank's management computer system with at least one processor verify the validity of the image, and communicate back with said ATM to proceed with the transaction,
said ATM requests user to enter PIN (personal Identification Number) associated with the account.
Said ATM sends PIN entry to the account management system for verification and for authorizing transactions. Transaction is permitted once account is verified.

10- A method of financial transaction allowing account holder and authorized users to execute ATM/bank teller device's transactions without using debit card comprising:
A readable coded image associated with the customer's bank account.
Said readable image is on a mobile electronic device for display of the image by the user to ATM and bank teller devices,
Said readable image is printed on a document for display of the image by the user to ATM and bank teller devices
Said ATM and bank teller devices are capable of reading the displayed image, wherein displaying of the image causes the ATM to initiate the communication with the transaction management system for verification of the image,
said ATM receives verification, said ATM requests user to enter PIN (personal Identification Number) associated with the account.
Said ATM sends PIN entry to the account management system for verification and for authorizing transactions. Transaction is permitted once account is verified.

11- A system allowing bank account holder and authorized users to automatic issuing and printing of a cashier check online comprising:
A readable coded image associated with the customer's bank account, said coded image is on a mobile electronic device for display of the image by the user,
A mobile application and/or URL (Uniform Resource Locator) is provided to account customer and authorized users to access their accounts using the coded image associated with their accounts,
Said application/URL is capable of capturing and reading the image presented by the customers from their mobile device,
Wherein user transmits the image to said application/URL,
Wherein receiving and reading the image by said application/URL initiate communication with the account management system,
Wherein said application/URL allow users to access the account after entering the correct PIN, associated with the account,
Wherein said application/URL allows authorized user to edit on the page name of payee, amount to be paid, name of payer,
Wherein said application/URL displayed a drafted cashier check to the user for approval,
Said displayed check contains information given by the user, bank information in text, account information in text, coded information of the check printed as a readable barcode, image code of the customer account may also be added,
Wherein said application/URL issues a printable cashier check once the user submits his approval.

12- A system according to claim 11 wherein said application is capable of reading an image, uploaded to said application/URL, in PDF, PNG, and other document formats,

13- A method of financial transaction allowing account holder and authorized users to automatic issuing and printing of a cashier check online comprising:
a readable coded image associated with the customer's bank account.
Said coded image is on a mobile electronic device for display of the image by the user,
Said coded image is printed on a document for display of the image by the user,
A mobile application and/or URL (Uniform Resource Locator) is provided to account customer and authorized users to access their accounts using the coded image associated with their accounts,
Said application/URL is capable of capturing and reading the image presented by the customers from their mobile device,
Said application is capable of reading an image, uploaded to said application/URL, in PDF, PNG, and other document formats,
Wherein user transmits the image to said application/URL,
Wherein receiving and reading the image by said application/URL initiate communication with the account management system,
Wherein said application/URL allow users to access the account after entering the correct PIN, associated with the account,
Wherein said application/URL allows authorized user to edit on the page name of payee, amount to be paid, name of payer,
Wherein said application/URL displayed a drafted cashier check to the user for approval,
Said displayed check contains information given by the user, bank information in text, account information in text, coded information of the check printed as a readable barcode, image code of the customer account may also be added,
Wherein said application/URL issues a printable cashier check once the user submits his approval.

14- A system for financial transaction allowing account holders to pay bill, and make payment online for purchasing without disclosing any personal information comprising of:
A buyer with readable image code account on a mobile electric device,
Online merchant accepting image code transaction,
A third party automatic verification system (TPAVS),
Bank account managing computer,
Wherein the buyer having a readable coded image associated with his bank account.
Said coded image is on a mobile electronic device of the user,
Said buyer transmitting the image, with the associated PIN, to said TPAVS,
Wherein TPAVS verifies the transaction with the buyer's account managing system,
Wherein said buyer's account managing system approves or denies the transaction,
said TPAVS receive authorization message meaning approval of the transaction,
Wherein TPAVS complete the transactions between the buyer and the seller with confirmation of the transaction send to both.

15- A method for financial transaction allowing account holders to pay bill, and make payment online for purchasing without disclosing any personal information comprising of:
A readable coded image associated with the customer's bank account.
Said coded image is on a mobile electronic device for transmitting the image by the user with the associated PIN, to a third-party Automatic verification system (TPAVS),
Wherein TPAVS verifies the transaction with the buyer's account managing system,
Wherein said buyer's account managing system approves or denies the transaction, when the transaction is approved a payment receipt is issued with approval number, said approval receipt is transmitted to TPAVS,
Wherein TPAVS complete the transactions between the buyer and the seller with confirmation of the transaction send to both.
Wherein seller on their application/URL provides buyers the option of barcode image as a method of payment.

16- A system for financial transaction allowing account holders to pay for merchant at point of sale without using his debit card comprising;
a mobile electronic device for display of the image by the user to merchant's scanner, said readable coded image is associated with the customer's bank account,
merchant scanner capable of reading the coded image,
Bank account management system, to verify and authorize the transaction,
wherein displaying of the image causes said scanner to initiate communication with the Bank account management system, for verification of the image,
when said scanner receives verification of the image it requests user to enter the PIN (personal Identification Number) associated with the account.
said scanner send submitted PIN to the bank account management system for verification and for authorizing transactions, said transaction is completed when authorization is received by the seller.

17- A method for financial transaction allowing account holders to pay for merchant at point of sale without using his debit card comprising;
A readable coded image associated with the customer's bank account,
Said coded image is on a mobile electronic device for display of the image by the user to the merchant's scanner,
Said merchant scanner is capable of reading the coded image,
wherein displaying of the image causes said scanner to initiate the communication with the transaction management system for verification of the image,
wherein when said scanner receives verification of the image it requests user to enter the PIN (personal Identification Number) associated with the account.
Said scanner send submitted PIN to the account management system for verification and for authorizing transactions.
